(19) United States
(12) Patent Application Publication
(10) Pub. No.: US 2009/0212935 A1
(43) Pub. Date: Aug. 27, 2009

(54) Anti-collision Emergency Braking System

(75) Inventor: Qi Luo, San Jose, CA (US)

Correspondence Address: QI LUO, 6925 Sivergate CT, San Jose, CA, 95120, US

(73) Assignee: Qi Luo, San Jose, CA (US)

(21) Appl. No.: 12/036,260

(22) Filed: Feb. 24, 2008

(51) Int. Cl. B60Q 1/44

(52) U.S. Cl. 340/467

(57) ABSTRACT

An anti-collision emergency braking system enables emergency information transferring from leading vehicle to trailing vehicle and enables emergency automatic braking. It comprises a central commanding element which takes input from a number of sensing elements and gives commands to other acting elements: a receiver which receives emergency signals from the leading vehicle, a transmitter which sends out emergency signals toward the trailing vehicle, an accelerometer which senses the acceleration extents of the present vehicle, an automatic braking element which applies certain amount of braking power after receiving the commands from the central commanding element, and one or more warning elements.

### FIELD OF THE INVENTION

This invention relates to an anti-collision vehicle emergency braking system which enables automatic braking and emergency information transferring from leading to trailing vehicles. More particularly, the invention relates to a vehicle emergency braking system which includes functional elements of an accelerometer, a transmitter, a receiver, an automatic brake and its emergency warning elements.

### BACKGROUND OF THE INVENTION

Most vehicles are equipped with braking lights in the rear windshield to warn a trailing driver that the leading vehicle's brake is being applied. The braking lights help to reduce the trailing driver's perception time that a braking action is taking place in the leading vehicle. However, the braking lights do not tell the trailing driver whether this braking is just a normal speed adjustment or it is an emergency hard stop. So, the trailing driver needs to observe how quick the leading vehicle is slowing down, and then make a judgment that this is an emergency stop, so that he starts to apply full pressure on his braking pedal. The reacting process includes the early perception of the light, response thereto, mental calculation of the speed change of the leading vehicle, and application of proper deceleration. This reacting process may take certain amount of time ranging from tenths of seconds to a few seconds depending on the driver, and the whether conditions. In an emergency situation, this reacting process could be fatal. And, from time to time, drivers may be distracted away from the regular view field therefore may not perceive the warning signal at the earliest time. Such situation may cause significant delay for the driver to brake. In addition, during less than ideal weather conditions such as foggy, heavy snow, or raining, the braking signals may not be clear to the trailing drivers, and this will cause further delay of reaction. The driver in a dangerous situation may not react in time, and as a result, the driver may not have enough time to bring his vehicle to a safe stop and run into a collision.

A number of prior arts are working on automatic vehicle brake controlling systems. For example, U.S. Pat. No. 6,922,624, Vehicle Brake Control Apparatus, issued to Kazuyoshi Isaji etc., discloses a system which has inter-vehicle distance and speed detecting apparatus and automatic braking apparatus. Similar apparatus are disclosed in US Pat. Appl. No. 2004/0193351, 2005/0010352, 2006/0097504, etc. Such apparatuses have detecting elements which either use active radar detectors or use optical imaging systems to detect and obtain the distance and speed information of the obstacles in front of the driving vehicle; upon obtaining this information, the system makes proper commands to take emergency actions, such as automatic braking, etc.

In above prior arts, from emergency information detection to proper emergency reaction, only the present driving vehicle is involved, yet no inter-vehicle communication is involved; also the detection and image processing involve complex systems. It will be of great interest if emergency information can be transferred from leading vehicle to trailing vehicles in its earliest time, so that the trailing vehicles can be prepared at their earliest time. This can be realized if every vehicle is equipped with a similar automatic anti-collision emergency braking system which is capable of inter-vehicle communication. Such automatic anti-collision emergency braking system can receive emergency signals from its leading vehicle, and then take proper actions to slow down the vehicle speed in advance to that the driver can take proper response to the situation; meanwhile this system can also send out emergency signal toward the trailing vehicle, so that the similar automatic anti-collision emergency braking system in the trailing vehicle can receive the emergency information and take proper actions accordingly. This will dramatically simplify the detecting system and also shorten the emergency reaction time.

### SUMMARY OF THE INVENTION

In view of the above-mentioned interest, the objects of the present invention and its preferred embodiments are discussed below. For ease of description, three terminology terms are used regarding the situation where three vehicles in a row are driving on the road. A “present vehicle” is the middle vehicle which is the primary focus of the present invention; a “leading vehicle” is the vehicle in front of the present vehicle; a “trailing vehicle” is the vehicle following the present vehicle. All three vehicles have installed the present-invented anti-collision emergency braking system.

It is then an object of the present invention to provide vehicles with an anti-collision emergency braking system, which has a function to receive emergency signals from a leading vehicle, and also has a function to send out emergency signals toward the trailing vehicle. Here, the emergency signal from the leading vehicle could be an emergency braking of the leading vehicle or some emergency situations of the vehicles in front of the leading vehicle; the emergency signal sending out to the trailing vehicle could be the emergency situation passed from the leading vehicle or the emergency braking of the present vehicle if the driver has depressed the brake pedal for a hard stop.

It is another object of the present invention that the anti-collision emergency braking system has an automatic braking function. Upon receiving the emergency signal from the leading vehicle, the controlling system can send out commands to an automatic braking element, so that the automatic braking element can start the procedure of automatic braking, if the driver still has not realized the emergency situation yet.

It is another object of the present invention that the anti-collision emergency braking system works harmonically with the regular hydraulic foot braking system which has key elements of a master cylinder, a piston and a foot-braking pedal.

In order to accomplish the above-mentioned and other related objects, the present invention provides an anti-collision emergency braking system with following functional elements: a central commanding element which takes input from a number of sensing elements and gives commands to some other acting elements, a receiver which receives emergency signals from the leading vehicle, a transmitter which sends out emergency signals toward the trailing vehicle, an accelerometer which senses the acceleration extents of the present vehicle, an automatic braking element which applies certain amount of braking power after receiving the commands from the commanding element, one or more warning elements, and some other periphery elements.

According to a preferred embodiment of the present invention, the anti-collision emergency braking system works while the driver of the present vehicle observes a danger situation and takes an emergency hard brake onto the brake pedal. At the time the driver takes the hard press to the brake pedal, the accelerometer will sense the deceleration extent. While the deceleration extent exceeds a pre-determined threshold, the accelerometer sends out an signal to the central commanding element, which will thereafter activate the transmitter which will then send out a series of radio frequency signals toward the rear direction, in the hope that the receiver of anti-collision emergency braking system in the trailing vehicle can receive these signals, so that the trailing vehicle and its driver can take proper actions accordingly.

According to another preferred embodiment of the present invention, the anti-collision emergency braking system works in a situation that a leading vehicle is experiencing an emergency braking. It is assumed that the leading vehicle has also installed a similar anti-collision emergency braking system. While the leading vehicle experiences an emergency braking, its transmitter sends out a series of radio frequency signals toward the rear direction. The receiver of the present vehicle will receive these emergency signals. Upon receiving these signals, the commanding system of the present vehicle then starts a set of emergency reactions, such as starting the automatic braking, warning the trailing vehicle, etc.

In one embodiment of the present invention, the anti-collision emergency braking system has an automatic braking element, which can apply certain amount of braking force to the wheels after it receives command from the emergency-commanding element.

In one embodiment of the present invention, the anti-collision emergency braking system may also include an emergency audio warning element, which may be installed inside the car, preferably on the dashboard next to the driver.

In one embodiment of the present invention, the anti-collision emergency braking system may also include an emergency warning light element, which may be installed in the rear of the vehicle.

In one embodiment of the present invention, the anti-collision emergency braking system has two functional coordinating elements, which are an electronically actuated back-locking element and a pressure sensor attached on the back-locking element. These two functional elements help the automatic braking element work harmonically with the regular foot-braking system.

In another embodiment of the present invention, the anti-collision emergency braking system may also have its central commanding system connected to a sensor on the gas pedal. While the driver depresses the gas pedal, this sensor senses the pressure on the gas pedal, then sends a signal to the central commanding element, and the central commanding element then sends a series of reset signals to the automatic braking element, the emergency warning light, the transmitter etc. This will bring the vehicle back to normal driving conditions.

In another embodiment of the present invention, the anti-collision emergency braking system may have a primary working radio frequency for both its transmitter and its receiver. This frequency should be a frequency not used by any radio station in the selected area or in the whole United States.

In another embodiment of the present invention, the anti-collision emergency braking system may have its primary radio frequency transmitted in a pre-determined direction with certain distribution, preferably within a limited distribution angle.

in another embodiment of the present invention, the anti-collision emergency braking system may have its radio frequency signal to have certain strength, so that the signal strength decreases to a certain limiting value, that the trailing vehicle may not receive it. This would transfer into a distance limitation.

In another embodiment of the present invention, the anti-collision emergency braking system may work both at high driving speed and at middle driving speed. It may have two settings for some of its functional elements, such as frequency, accelerometer, and its various sensors, and its central commanding element will take inputs of the current driving speed, and accordingly uses the correct settings for the involved functional elements, so that proper action can be taken.

### BRIEF DESCRIPTION OF THE DRAWINGS

FIG. 1 is a flowchart illustrating the controlling logic of an anti-collision emergency braking system.

FIG. 2 schematically shows the functional elements of an anti-collision emergency braking system in a vehicle.

FIG. 3 is a schematic drawing showing an automatic hydraulic braking system.

### DETAILED DESCRIPTION OF THE INVENTION

The following detailed description is directed to certain specific embodiments with reference to the accompanying drawings, in which certain specific embodiments are shown. This invention may, however, be embodied in many different forms and should not be construed as limited to the embodiments set forth herein.

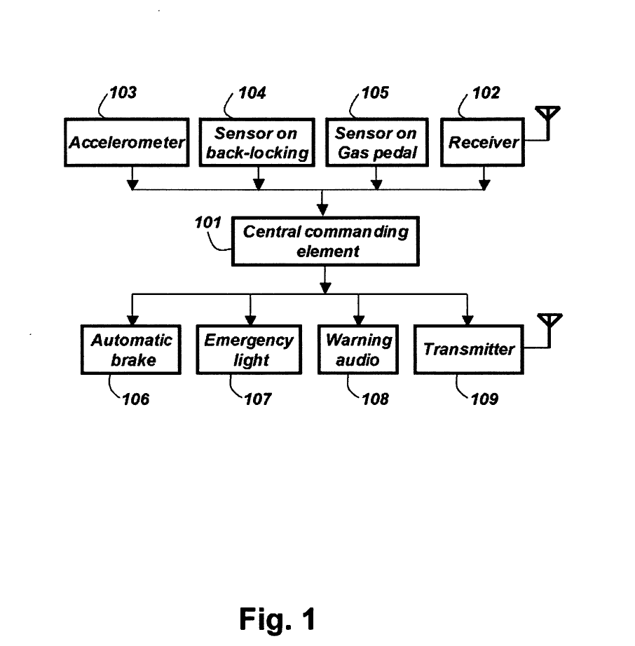

FIG. 1 is a flowchart illustrating the controlling logic of an anti-collision emergency braking system and its working mechanism. The core part of the system is a central commanding element 101. It takes input from four functional elements: a receiver 102, an accelerometer 103, a sensor on back-locking 104, and a sensor on gas pedal 105. Upon receiving the signals from these four functional elements, the central commanding element 101 will send out control signals to four other functional elements: an automatic brake 106, an emergency light 107, a warning audio 108 and a radio frequency transmitter 109. These four elements will be turned on or off depending on the received control signal, so that proper operations are taken.

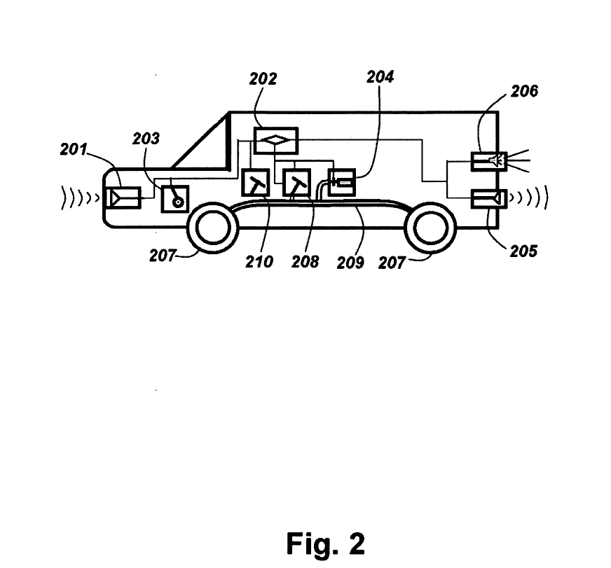

FIG. 2 schematically shows the functional elements of the present invented anti-collision emergency braking system in a vehicle and the relationship between the functional elements. In the front part of the vehicle is the receiver 201, which is used to receive the radio frequency emergency braking signals from the leading vehicle in front of the present vehicle. Upon receiving such an emergency signal, the receiver 201 passes an emergency signal to the central commanding element 202. In the front of the vehicle, there is also an accelerometer 203, which is used to detect any deceleration; while the deceleration exceeds some pre-determined value, the accelerometer 203 also passes an emergency signal to the central commanding element 202. Upon receiving the emergency signal from either the receiver 201 or the accelerometer 203, the central commanding element 202 will send signals to following parts: an automatic brake 204, an emergency braking signal transmitter 205 which is located in the rear of the vehicle, and an emergency warning light 206 which is installed in the rear of the vehicle. The automatic brake 204 is a hydraulic pressure system which may have its own pressure generator and a valve to connect this hydraulic pressure system to the main hydraulic foot-braking pressure system. While the automatic brake 204 is switched on, its braking power is applied to the wheels 207. The main hydraulic braking pressure system includes the regular master cylinder (not shown here), the regular foot brake pedal 208, and the regular hydraulic system 209. The vehicle has its regular gas pedal 210. The gas pedal 210 has a sensor connected to the central commanding element 202. Whenever the gas pedal 210 is pressed, the sensor on it will send a signal to the central commanding element 202, which will then send signals to the automatic brake 204, the transmitter 205, and the emergency light 206 to reset them and release the emergency conditions.

The functional elements in above descriptions are only for purpose to illustrate the working mechanism of a preferred embodiment of the invention. Each functional element may have multiple forms with various designs. This embodiment is provided so that this application will be through and complete, and will fully convey the true scope of the invention to those skilled in the art.

In one preferred embodiment, the anti-collision emergency braking system works while the driver of the present vehicle observes a dangerous situation and takes an emergency hard brake onto the brake pedal 208. At the time the driver takes the hard press to the brake pedal 208, the accelerometer 203 will sense the deceleration extent. While the deceleration extent exceeds some threshold, the accelerometer 203 sends out a signal to the central commanding element 202, which will thereafter activate the transmitter 205, which will then send out radio frequency signal toward the rear direction, and emergency warning light 206, which will then be turned on, in the hope that the receiver of the trailing vehicle can receive this signal or the driver will see the warning light, so that the trailing vehicle and its driver can take proper actions accordingly.

In another preferred embodiment, the anti-collision emergency braking system works in a situation when a leading vehicle is experiencing an emergency braking. It is assumed that the leading vehicle has also installed a similar anti-collision emergency braking system. The leading vehicle's emergency braking could be that its driver brakes hard onto the brake pedal or the automatic braking initialized by its anti-collision emergency braking system. While the leading vehicle experiences such emergency braking, its transmitter sends out an emergency signal toward its rear direction, and this emergency signal will be received by the receiver 201 installed in the present vehicle. Upon receiving this signal, the central commanding element 202 of the present vehicle does a few things. First, it activates the automatic brake 204 which will apply a certain amount of braking power to the wheels; meanwhile, it turns on the emergency warning light 206, and activates the transmitter 205 which will then send out a series of radio frequency signals toward the rear direction in a hope that the trailing vehicle, if any, receives the information that the present vehicle is either experiencing an emergency braking, or is preparing for an emergency braking due to emergency conditions in the leading vehicle or vehicles, so that the trailing vehicle and its driver can take proper actions.

In one embodiment, the anti-collision emergency braking system may also include an emergency warning audio element, which may be installed inside the car, preferably on the dashboard next to the driver. Upon receiving an emergency braking signal from the leading vehicle, the central commanding element 202 may activate this audio warning element, thereafter the audio element can make some sounds to warn the driver the emergency situation, so that the driver can be prepared to apply full braking power to the brake pedal 208, if that is needed and he is not doing that yet.

In one embodiment, the emergency warning light element 206 may be a dedicated warning light, different from the regular braking lights. Upon receiving an emergency braking signal from the leading vehicle or upon receiving the emergency braking signal from the accelerometer 203 installed in the present vehicle, the central commanding element 202 of the present vehicle may activate this emergency warning light 206, thereafter the emergency warning light 206 can light up to warn the trailing vehicle that an emergency braking is happening in the present vehicle or the leading vehicles, so that the trailing driver can be prepared for the coming emergency situation. This emergency warning light 206 works together with the transmitter 205 of the present vehicle to provide early emergency warnings to the trailing vehicle.

In one embodiment, the anti-collision emergency braking system may have its central commanding element 202 also connected to a sensor on the gas pedal 210. While the driver depresses the gas pedal 210, this sensor senses the pressure application on the gas pedal 210 or the movement of the gas pedal 210 away from its idle position. Upon obtaining the signal that the gas pedal 210 is pressed, the sensor sends a signal to the central commanding element 202, and the central commanding element 202 then sends a series of reset signals to the automatic brake element 204, the transmitter 205, the emergency warning light 206, etc. This will bring the vehicle back to normal driving conditions.

In one embodiment, the anti-collision emergency braking system may have a primary radio frequency for both its receiver 201 and its transmitter 205. This frequency should be a frequency not in use by any radio station in a pre-determined area, which could be, any state, or the whole United States, or even the whole North America.

In another embodiment, the anti-collision emergency braking system may have its radio frequency signal transmitted in a pre-determined direction, preferably the rear direction, with distribution in a limited angle from 5 to 45 degree, preferably around 10 degree.

In another embodiment, the anti-collision emergency braking system may have its radio frequency signal to have certain strength, so that, away from a pre-determined distance, the signal strength decreases to a pre-determined strength at which the trailing vehicle at that distance may not be able to detect this signal. This pre-determined distance should be larger than the minimum safe-driving distance required by the state law. This setting should reduce a lot unnecessary automatic emergency braking from the tailing vehicles.

In another embodiment, the anti-collision emergency braking system may work at different driving speeds, for example, at high speed (60 MPH or higher), or at middle speed (40 to 60 MPH). To work in this large range of speed, the anti-collision emergency braking system may have two primary working radio frequencies, one for high speed freeway driving, and the other for middle speed driving. Accordingly, the receiver 201 and the transmitter 205 may be designed to work on both frequencies; also the threshold of the deceleration extent, the pre-determined automatic braking pressure, and the transmitting radio frequency signal strength will also have two corresponding settings. The central commanding element 202 takes input of the current driving speed, and accordingly uses the correct settings for the related functional elements, so that proper actions are taken.

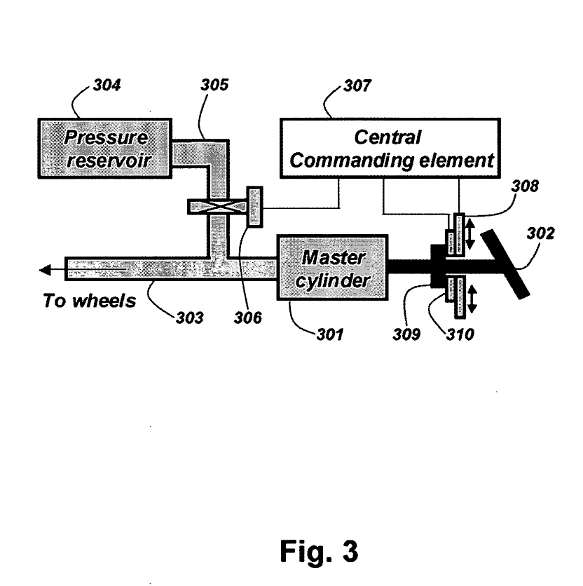

FIG. 3 illustrates one preferred embodiment of an automatic braking system, referenced as automatic brake 106 in FIG. 1 and automatic brake 204 in FIG. 2. For ease of description, a regular foot-braking system is also shown. The regular foot-braking system includes a master cylinder 301 with its piston (not shown here), a foot-braking pedal 302, and a hydraulic pressure transmitting tubing 303, through which braking power is transmitted to the wheels. The automatic braking system has a pressure reservoir 304, which maintains a fixed pressure through the embedded pressure generation system in the vehicle. This pressure is directly related to the braking power. The pressure reservoir 304 is connected to the regular hydraulic transmitting tubing 303 through similar tubing 305. A solenoid valve 306 is used to turn on or turn off this connection. This solenoid valve is controlled through the electronic signal from a central commanding element 307, referenced as central commanding element 101 in FIG. 1 and central commanding element 202 in FIG. 2. A back-locking element 308 is used to back-lock the piston of the master cylinder 301 through a standoff plate 309 which is mounted on the end portion of the piston where the foot brake pedal is attached. This back-locking element 308 is switched into or switched out of its working position based on the signal from the central commanding element 307. On the top of the back-locking element, a pressure sensor 310 is attached, which can sense the pressure the piston applies on the back-locking element 308, thus tell the engagement of the piston and the back-locking element 308.

In one embodiment, the automatic braking system can apply a pre-determined amount of braking power to the wheels through the hydraulic pressure transmitting tubing 305 and 303. In an emergency situation, the central commanding element 307 first sends signals to actuate the back-locking element 308 to move it into the working position so that it will prevent the piston of the master cylinder 301 from being pushed back later by the hydraulic pressure from the pressure reservoir 304; meanwhile, the central commanding element 307 turns on the solenoid valve 306 so that the pre-determined braking pressure is transmitted to the braking device on the wheels, and certain amount of braking power is applied to the wheels. This pre-determined braking power could be from 0% to 100%, preferably 40%, of the maximum braking power of the foot brake. The back-locking element 308 is important because it prevents the piston of the master cylinder 301 from retreating, thus maintains the hydraulic pressure and ensures that the automatic braking system can maintain stable braking power.

The back-locking element 308 and the pressure sensor 310 help the automatic braking system work harmonically with the regular master cylinder foot braking system. One hand, in a situation that the automatic braking system has started working, yet the driver did not press the brake pedal 302 or his pressing power is less than the automatic braking power, the back-locking element 308 helps to prevent the piston from withdrawing and to maintain the automatic braking pressure inside the hydraulic system, therefore the stable braking power; on the other hand, while the driver's foot braking power is greater than the automatic braking power, the piston will be detached from the back-locking element 308 and the pressure sensor 310 will sense this detachment and pass this information to the central commanding element 307, then the central commanding element 307 can order the solenoid valve 306 to close, so that the automatic braking hydraulic system is no longer connected to the master cylinder hydraulic system. After that, the braking power control will be solely on the driver.

While the above detailed descriptions have shown novel features of the invention in various example embodiments, it is understood that various omissions, substitutions, and changes may be made to the forms and details of the discussed embodiments by those skilled in the art without departing from the spirit of the invention. Many variations in light of the described embodiments herein will be appreciated by those skilled in the art.

What is claimed is:

1. An anti-collision emergency braking system of a vehicle comprises:
a receiver which is located in the front of the vehicle, and
an accelerometer, and
an automatic brake, and
a transmitter which is located at the rear of the vehicle, and
an emergency warning light which is located at the rear of the vehicle, and
a central commander, and
a sensor, which is mounted on the gas pedal.

2. The anti-collision emergency braking system of claim 1, wherein the accelerometer detects the deceleration of the vehicle and, while the deceleration extent exceeds a pre-set threshold, sends a signal to the central commander so that the central commander can take proper actions to slow down the vehicle and warn the trailing vehicle.

3. The anti-collision emergency braking system of claim 1, wherein the receiver is designed to receive the emergency braking signal from the vehicle in front, and, upon receiving such radio frequency signal, to send an electrical signal to the central commander so that the central commander can take proper actions to slow down the vehicle and warn the trailing vehicle.

4. The anti-collision emergency braking system of claim 1, wherein the transmitter is designed to emit radio frequency signal toward the rear direction of the vehicle, indicating that the vehicle is experiencing emergency braking.

5. The anti-collision emergency braking system of claim 1, wherein the central commander is a controlling system which takes inputs from the receiver, the accelerometer, the sensor at the gas pedal, and some other sensors, and gives commands to the automatic brake, the transmitter, the emergency warning light, and some other functional elements.

6. The anti-collision emergency braking system of claim 1, wherein the automatic brake takes command from the central commander, and then applies a pre-determined amount of braking power to the wheels.

7. The anti-collision emergency braking system of claim 1, wherein the emergency warning light is controlled by the central commander, and lights up while the central commander determines an emergency condition exists.

8. The anti-collision emergency braking system of claim 1, wherein the sensor on the gas pedal, upon sensing the depression of the gas pedal, sends out a signal to the central commander which then sends signals to reset the automatic brake, the transmitter, the emergency warning light, and therefore releases the emergency condition.

9. The anti-collision emergency braking system of claim 1, wherein the automatic brake comprises:
a hydraulic pressure reservoir, which maintains a pre-determined amount of pressure, and
a hydraulic tubing, which connects the hydraulic pressure reservoir with the regular hydraulic foot braking system, and
a solenoid valve, which is controlled by the central commander as in claim 1, and is designed to open or close the hydraulic tubing.

10. An automatic braking system of a vehicle comprises:
a regular hydraulic foot braking system, including a master cylinder, which has a piston, and a foot-braking pedal, and
a hydraulic pressure reservoir, which is connected to the regular hydraulic foot braking system through hydraulic tubing, and
a solenoid valve, which controls the connection of the hydraulic pressure reservoir and the regular hydraulic foot braking system, and
a commanding element, which coordinates the involved functional elements, and
a back-locking functional element, and
a pressing sensor, which is attached on the back-locking functional element, facing a standoff fixture mounted on the piston of the master cylinder.

11. The automatic braking system of claim 10, wherein the hydraulic pressure reservoir maintains a pre-determined pressure.

12. The automatic braking system of claim 10, wherein the commanding element controls both the solenoid valve and the pressing sensor.

13. The automatic braking system of claim 10, wherein the solenoid valve can be actuated to turn on or off, through commands from the commanding element.

14. The automatic braking system of claim 10, wherein the back-locking functional element can be switched into or out of its working position, at which it prevents the piston from retreating from the master cylinder while the automatic braking system is on.

15. The automatic braking system of claim 10, wherein the pressing sensor senses the detaching of the piston from the back-locking element, and, upon sensing the detachment, sends a signal to the commanding element, which then turns off the solenoid valve.
